(19) United States
(12) Patent Application Publication
(10) Pub. No.: US 2009/0171784 A1
(43) Pub. Date: Jul. 2, 2009

(54) Method and apparatus for splitting advertising opportunities

(76) Inventors: Thomas J. Morgan, San Mateo, CA (US); Christopher A. White, Redwood City, CA (US); Matthew Wong, Palo Alto, CA (US); Leslie M. Carter, San Jose, CA (US); Mason T. Jones, San Francisco, CA (US)

Correspondence Address: TROP, PRUNER & HU, P.C., 1616 S. VOSS ROAD, SUITE 750, HOUSTON, TX, 77057-2631, US

(21) Appl. No.: 12/005,531

(22) Filed: Dec. 27, 2007

(51) Int. Cl. G06Q 30/00; G06Q 10/00; G06Q 20/00

(52) U.S. Cl. 705/14; 705/39; 705/30

(57) ABSTRACT

A dynamic advertising insertion system automatically inserts advertisements in response to opportunities that arise in the course of content playback. For example, when a user hits a pause button, an advertising opportunity may be created and an appropriate advertisement may be inserted. One basis for determining which advertisement to insert is to enforce a predetermined agreement between a content provider and one or more distributors that sets forth a percentage of advertising opportunities that each entity will be afforded. Thus, the decision of what advertisement to insert may be based on a number of factors, including the type of content, the particular user's equipment, information about the user, and the need to adjust the playback of advertisements to enforce the percentage split between the advertising entities.

### BACKGROUND

This relates generally to the dynamic insertion of advertisements into entertainment content.

An asset is video, rich media, audio, or graphic information that can be an advertisement or entertainment content. Content refers to any entertainment asset created by a content provider. Content is not used to refer to advertising assets. Content generally refers to an episode or a program, such as a group of episodes. A content provider is an organization responsible for the creation of content.

In connection with broadcast television, content providers cannot reach audiences without distributors. Distributors are organizations responsible for distributing content to a viewing audience. A distributor is also known as an operator. A distributor includes a cable television supplier, a satellite distribution supplier, a web portal, local affiliate broadcaster, mobile communications systems, fixed and mobile WiMAX systems and telephone systems, and a provider of video information, to mention a few examples. Distributors and content providers are collectively called “sellers” herein.

Advertisements sold by a content provider are generally national advertisements, while advertisements sold by a distributor are local advertisements.

Currently, the splitting of advertising opportunities, called ad splits herein, is performed contractually and the inventory of advertisements is allocated and divided uniquely between content providers and distributors.

In dynamic advertising insertion, ads are played for a given ad opportunity based on a client context. For example, any time certain user operations occur, an advertisement may be inserted. Examples of this include when the user begins play of content, when a user hits a pause icon, or when a period of time has passed, an advertisement may be inserted. Thus, the frequency of ad insertion, the number of ads that may be inserted, and the time when an ad is inserted may not be known in advance. In other words, the timing and number of advertising opportunities cannot be known in advance with dynamic advertising insertion.

### BRIEF DESCRIPTION OF THE DRAWINGS

FIG. 1 is a schematic depiction of a dynamic advertisement distribution system in accordance with one embodiment;

FIG. 2 is a flow chart for the set up sequence for implementing an advertising split through an automated dynamic advertisement distribution system according to one embodiment; and

FIG. 3 is a flow chart for the operation of an ad decision system according to one embodiment.

### DETAILED DESCRIPTION

In accordance with some embodiments of the present invention, a content provider may provide content to a content server for distribution to an audience. For example, a network television broadcaster may provide content to be broadcast by local television stations who act as distributors of the content. The content provider, in this case the national broadcaster, causes advertisements to be inserted into the content and provides the content to a large number of distributors in the form of local television broadcasters. Those local television broadcasters may also insert advertisements into the content.

Similarly, content may be distributed over satellite distribution systems, cable distribution systems, the Internet, or in media, such as DVD disks.

With dynamic advertisement insertion, advertisements are not simply inserted at fixed times or locations within content. Instead, the insertion of the advertisement depends on the particular context. For example, when certain things happen, advertisements may be inserted. Thus, advertisements may be inserted automatically in response to the beginning of play of content, the passage of time, a request for services, the selection of a pause feature to pause the playback of content, or any of a variety of other circumstances. Each of these circumstances may be difficult to predict and, therefore, no one may know the exact time when advertisements will be played, the exact demographics that may exist when the advertisements are played, the number of advertisements that may be played at any given time, or even the particular advertisements that may be played (which may be dependent on content as well).

Instead, an intelligent system determines what advertisements to play, under what circumstances, in response to a request for advertisements automatically generated from a content playback device. The decision about what advertisement to play may involve complex heuristics that take into account the demographics of the audience, the time of day, the time of year, the available advertisement pool, the type of playback device being utilized, the particular distributor or content provider, and the nature of the particular content being played, to mention a few examples.

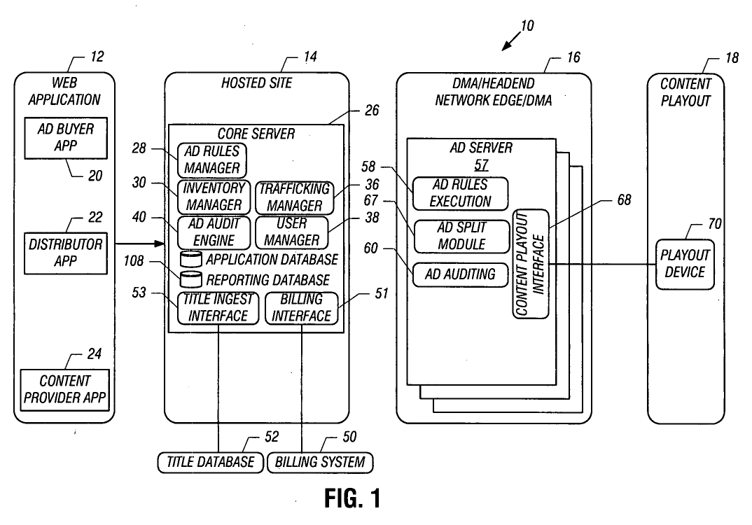

Referring to FIG. 1, a dynamic advertisement decision system 10 may include a web application 12. The web application 12 may be a software system accessible via a website by different users. These users can include content providers, distributors, and advertisers. The application suite may include a buyer application 20 that is used by advertisers to place or buy advertisements in the system for eventual insertion within content. It may also include a distributor application 22 for use by distributors to plan, create, and traffick an advertising campaign.

Thus, the distributor may initially set up a possible advertising campaign using the application 22. The distributor can later make that campaign accessible to others, such as advertisers. Finally, the distributor can commit to the campaign so that advertising opportunities set out on a website may be selected by advertisers. Finally, a content provider application 24 may be used by content providers to plan, create, and traffick advertising campaigns generally in the same way as the distributors.

The web application 12 may run on a web server at a hosted site 14. The hosted site 14 may be accessible to the various users over the Internet, as one example. The various users may access the hosted site through password protected portals or user interfaces.

The web server may include a core server 26 which includes the ad rules manager 28. The ad rules manager 28 compiles the ad campaign information and distributes it to the ad server 57. The campaign information may be entered via a website by content providers and distributors in one embodiment.

The core server 26 also runs a contract plan manager 32 that implements agreements with the various users of the system 10. These contracts may include agreements between sellers of advertisements, such as content providers and distributors, for the distribution of revenues gained from advertisers in return for advertisement placements within content and the splitting of advertising opportunities, also referred to as spots or ad avails.

An inventory manager 30 indicates what advertising opportunities are still unsold and available.

The trafficking manager 36 is responsible for assigning the creative content references to the campaign advertisements. The user manager 38 keeps track of user logins and their respective application privileges. This information may be important from an historical context.

An advertising audit engine 40 keeps track of whose advertisements got served and/or played. In other words, the engine 40 keeps track of who gets credit for the advertisements that were actually served and/or played. The credit may depend on the time when the advertisement is played, the targeting variables such as demographics of the audience to whom the content was played, or the particular content that was involved. All these circumstances may be collected or referenced by the audit engine 40, in some embodiments.

Also present within the hosted site 14 may be an application database and a reporting database. A title ingest interface 53 receives the titles that describe the content against which ads are to be placed against. These may be accessed from outside the hosted website 14 from a title database 52. Similarly, an external billing system 50 may be accessed by a billing interface 51 to allow the free flow of billing information to the billing system 50 from the reporting database.

A designated market area (DMA)/operator head end server or broadband network edge server that targets a dedicated market area 16 may receive ad campaign information for delivery to single DMA presentation or, in the case of a head end, may distribute to a number of DMAs. The head end or designated market area 16 may have an ad server 57 which includes an advertising rules execution engine 58, an ad split module 67, and an advertising auditing engine 60. The advertising rules execution engine 58 applies a set of heuristics to determine when a particular advertisement, known to be available, is to be inserted within particular content, for a particular user, at a particular time. The ad split module 67 splits the ad opportunities among sellers. The output of the rules execution engine 58 is advertisement play instructions. The auditing engine 60 accounts for the placement of advertisements.

A content playout interface 68 may interface to a playout device 70 in a content playout environment 18. The playout device 70 may be any type of playout device, such as a digital television, a set top box, a personal computer, a media player, a cellular telephone, a cable box, a Video On Demand server (VOD), a Digital Video Recorder (DVR), or a satellite receiver, to mention a few examples.

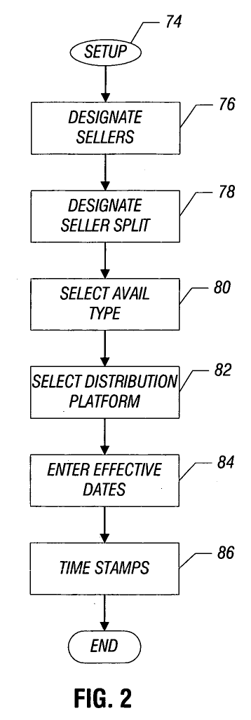

Referring to FIG. 2, the set up sequence 74 may establish an advertising inventory split in software. The set up sequence 74 may be executed at the hosted site 14 and may run as software executed by the core server 26 or ad server 57. The setup sequence can also be accomplished by the loading of a data file that contains the setup information, into the core server 26 or ad server 57. The sequence 74 establishes the set up of the system 10 which will make the ad decisions against the pre-defined advertising split settings.

Initially, at block 76, the group of sellers are designated. A seller may be a content provider or a distributor. Content providers and distributors may access the hosted site 14 to enter data about themselves and to register with the system 10.

Then, the seller split of advertising opportunities may be entered, as indicated in block 78. Generally, this is a percentage split which designates what percentage of the advertisement opportunities arising over a given period related to designated content would be provided to each of a selected group of designated sellers registered pursuant to block 76.

In block 80, the ad avail opportunity is defined. The ad avail opportunity is an advertising unit type that is associated with content. For instance, a pre-roll is an ad avail type. A pre-roll is defined as a video advertisement that plays before the main content is started. A mid-roll is a video advertisement that plays somewhere in the middle of the programming content, and a post-roll is a video advertisement that plays after the programming content is finished. A user selected ‘pause ad’ is still another avail type. A pause ad is advertisement that plays when a user pauses programming content. Any avail types may be utilized against any programming content to create advertising avail opportunities. In any case, in order to implement a seller contract, the avail opportunity must be entered. This provides the system with information it needs to know about the circumstances under which particular advertisements may be inserted.

Next, a distribution platform is selected at block 82. The distribution platform describes how video content is delivered to the play out device 70. For instance, distributors may distribute content on various application platforms, such as video on demand, broadband video, and digital broadcast television (cable or satellite), to mention a few examples.

Then, the effective dates of the advertising opportunities are entered (block 84). These may be entered as a starting date for the advertising campaign and an ending date. Again, this is information that is needed to determine when to insert the advertisements. More complex data may also be utilized, such as blackout dates or recurrent dates that extend over extended time ranges.

Also, time stamps may be entered, as indicated in block 86. Each ad split entry may include a time stamp and an indication of who and when the entry was created, in some embodiments.

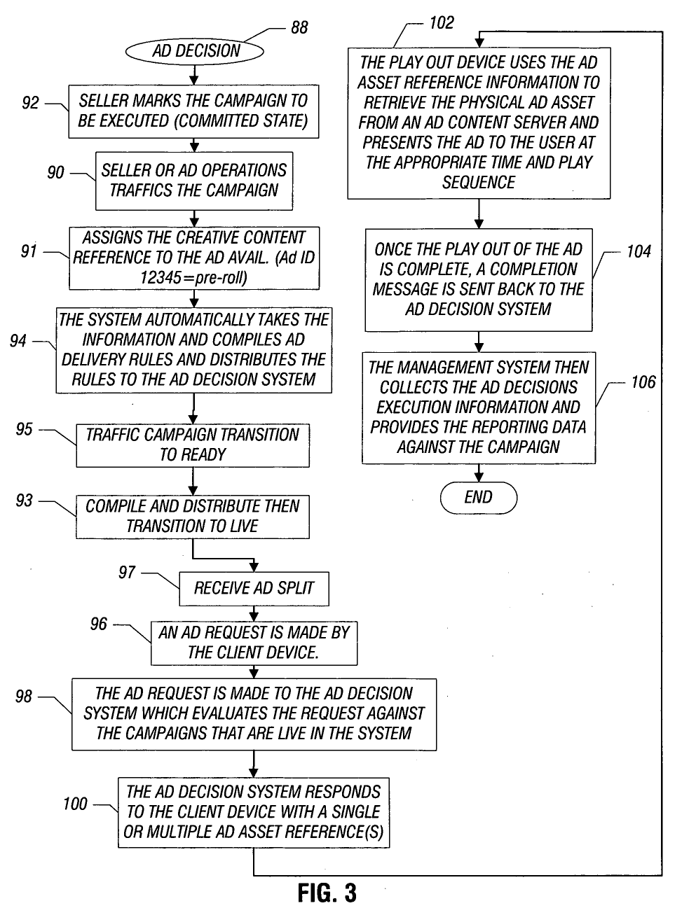

Referring to FIG. 3, an ad decision sequence is indicated at 88. The sequence 88 may be implemented in software. For example, the ad decision sequence 88 may be instituted by the ad rules execution engine 58 within the core server 26.

The seller marks the campaign to be executed (block 92). In one embodiment, this may involve transitioning the system 10 to indicate that the campaign is now in the committed state. Prior to the committed state, the campaign initially may be in open state where only the content provider or distributor can access the campaign on the website, for example to plan a campaign. Then, the seller can transition the campaign to “proposed” so that it can be reviewed by others, such as advertisers. However, the campaign is still not available for ad placement by a trafficker. Once the campaign is committed, it may be trafficked, meaning a trafficker may associate advertising creatives to specific campaigns by reference.

Then, a seller or ad operator trafficks a campaign, as indicated in block 90. To traffick the campaign means that the campaign is established within the host site 14 as described, for example, in connection with FIG. 2.

Next, the sequence assigns a creative content reference to an ad avail opportunity(block 91). For example, a particular ad may get an identifier such as “12345=pre-roll.” This ad identifier corresponds to data in a table that is maintained by the core server 26 to identify a particular advertisement to be inserted at a particular situation.

Next, as indicated in block 94, the system 10 automatically takes the information and compiles ad delivery rules and distributes the rules to the ad decision system 10. Alternatively, the same operations can be done manually.

Thereafter, the system 10 trafficks the campaign and transitions to the ready state, as shown in block 95. The campaign is compiled and distributed and then the system transitions to the live state, as indicated in block 93. The system transitions to live where ads are actually placed, as indicated at block 95. The system then receives the ad split setup information(block 97).

When an ad request is made by a play out device 70, as indicated in block 96, the decision system 10 evaluates the request against the advertising campaigns that are live within the system 10 (block 98).

The ad decision system 10 then responds to the client play out device 70 with a single or multiple ad asset identifiers, as indicated in block 100 (or with no assets if no matches are found). The play out device 70 uses the ad asset identifier information to retrieve the physical advertising asset from an ad content server (not shown) that presents the advertisement to the user at the appropriate time and play sequence, as indicated in block 102.

Once the play out of the advertisement is complete, a completion message is sent back to the advertising decision system, as indicated in block 104. The decision system 10 then collects the ad decision's execution information and delivers the result to the reporting database, as indicated in block 106.

To this end, the reporting database 108 will contain the data that enumerates the advertisements which have been played according to the percentages designated between the sellers as defined by the ad split setup information. Then the billing invoices associated with the advertisements may be generated by the sellers via a billing system.

As a result, in some embodiments, two different sellers can sell target traffick in an ad campaign against the same advertising opportunities.

Among the basis for making a decision about what ad to play in a given play out context, will include the percentage ad split that was pre-agreed between the sellers. Thus, if one seller has already had his or her running proportionate share of advertisements played, the next insertion opportunity may go to the other seller so as to implement the percentage split that was already entered into the system 10.

Thus, the system maintains information about which ads have been played against a given campaign such that making an ad placement decision based on the ad split percentage allocation can be automatically implemented. This occurs despite the fact that it is not known which ads will by played when or under what circumstances.

In some embodiments, the ad splits between two sellers may be based on specific targeting parameters such as demographic information. For example, the split percentage may be different, depending on the demographics of the viewing or listening audience. Additionally, ad split definitions may have a specific start and end date and, therefore, ad splits may change depending on the calendar date.

As a specific example, a broadband split agreement is determined between a content provider and a distributor. The content provider then generates the content for the purpose of delivery over a broadband based, on demand, network. In this example, the content provider uses advertising to recover content production costs. The content provider chooses a sponsorship advertising package model consisting of a pre-roll, mid-roll, and post-roll associated to the content. The three ad types are sold as a bundle to an advertiser in this example. More specifically, a given content program may be “brought to you by” a specific advertiser such that all the advertising opportunities associated to the content TV series will be populated by this advertiser.

The content provider then negotiates with a distributor and decides to make available a portion of the sponsorship avail opportunities to the distributor. The content provider and distributor agree to split ad inventory against the broadband content. Ultimately, this will allow the distributor to act as a second seller to sell a portion of the sponsorship package to a second advertiser.

Next, the content provider creates an ad split file which, in one embodiment, may be a comma separated values (CSV) file. The content provider adds information to an entry within the system, including the content provider percentage, the distributor percentage, the avail opportunity, the distribution platform, the effective start date based on the agreement between the content provider and the distributor.

Thereafter, the content provider submits the CSV file to the system 10. The system 10 verifies that the ad split file was received. Once an ad split entry effective start date is reached, the ad split entry becomes active. The ad split entry may be included in a rules compilation package. The system then begins making advertisement insertion decisions for the distributor when viewing the associated content provider's content and enforces the specified advertising split.

While an embodiment is described where the ad splits are flat, more than one splitting level may also be implemented. For example, two sellers may split ads in an agreed percentage (level 1) and then one of those sellers could split its percentage with two others (level 2), one of who may split its percentage with others (level 3).

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
automatically splitting advertising opportunities in a dynamic advertisement insertion system between at least two advertising sellers based on a predetermined percentage.

2. The method of claim 1 including enabling a content provider or distributor to access a website to enter the predetermined percentage.

3. The method of claim 2 including automatically selecting advertisements to insert in said dynamic advertisement insertion system.

4. The method of claim 3 including automatically selecting the advertisements to insert at least in part based on the context of an advertising opportunity.

5. The method of claim 4 including using the percentage to decide which advertisements to insert.

6. The method of claim 5 including automatically playing that predetermined percentage of advertisements of the content provider and the distributor.

7. The method of claim 1 including implementing an advertising campaign having effective dates for the predetermined percentage.

8. The method of claim 2 including automatically determining the revenues from advertisement insertion and automatically distributing those revenues between the distributor and the content provider.

9. The method of claim 2 including providing an interface to enable a content provider to enter an advertising opportunity into a web based system including a distribution platform and an avail type.

10. The method of claim 1 including providing references to advertisements stored at a remote server to enable the selected advertisement to be played at a particular time.

11. A computer readable medium storing instructions executable by a computer to:
split advertising opportunities in a dynamic advertisement insertion system between at least two advertising sellers based on a predetermined percentage.

12. The medium of claim 11 further storing instructions to enable a content provider or distributor to access a website to enter the predetermined percentage.

13. The medium of claim 12 further storing instructions to automatically select advertisements to insert in said dynamic advertisement insertion system.

14. The medium of claim 13 further storing instructions to select the advertisements to insert at least in part based on the context of an advertising opportunity.

15. The medium of claim 14 further storing instructions to use the percentage to decide which advertisements to insert.

16. The medium of claim 15 further storing instructions to play that percentage of advertisements of the content provider and the distributor.

17. The medium of claim 11 further storing instructions to implement an advertising campaign having effective dates for the predetermined percentage.

18. The medium of claim 12 further storing instruction to determine the revenues from advertisement insertions and automatically distribute those revenues between the distributor and content provider.

19. The medium of claim 12 further storing instructions to provide an interface to enable a content provider to enter an advertising opportunity into a web based system including a distribution platform and an ad avail type.

20. The medium of claim 11 further storing instructions to provide references to advertisements stored at a remote server to enable the selected advertisement to be played at a particular time.

21. A dynamic advertising insertion system comprising:
a server; and
a storage storing instructions executable by said server to split advertising opportunities in said system between at least two advertising sellers based on a predetermined percentage.

22. The system of claim 21 including a trafficking manager to assign creative content references to advertisements.

23. The system of claim 21 including an audit manager to keep track of credit for ads that were played.

24. The system of claim 21 including an inventory manager to keep track of unsold advertising opportunities.

25. The system of claim 21 including an ad rules manager to compile an advertising campaign based on website inputs from advertising sellers.
